(19) United States
(12) Patent Application Publication
(10) Pub. No.: US 2008/0133408 A1
(43) Pub. Date: Jun. 5, 2008

(54) SYSTEMS AND METHODS FOR USER AUTHORIZED CUSTOMER-MERCHANT TRANSACTIONS

(76) Inventor: Brett A. Nakfoor, Carlsbad, CA (US)

Correspondence Address: MCANDREWS HELD & MALLOY, LTD, 500 WEST MADISON STREET, SUITE 3400, CHICAGO, IL, 60661, US

(21) Appl. No.: 11/924,302

(22) Filed: Oct. 25, 2007

Related U.S. Application Data
(60) Provisional application No. 60/862,917, filed on Oct. 25, 2006.

(51) Int. Cl. G06Q 40/00

(52) U.S. Cl. 705/40

(57) ABSTRACT

Certain embodiments of the present invention provide methods and systems for user authorized transactions. Certain embodiments provide a method for facilitating user authorized transactions between a customer and a merchant. The method includes generating account information for a merchant for a transaction, the account information relating to payment of funds to a merchant in exchange for a good or service pending user authorization. The method also includes facilitating access to a user account to view transaction information for the transaction, the transaction information corresponding to the account information provided to the merchant. The method further includes authorizing payment from account for the transaction based on user approval following user review of the transaction information.

### RELATED APPLICATIONS

The present application claims priority to U.S. Provisional Patent Application No. 60/862,917 filed on Oct. 25, 2006, entitled “Systems and Methods for User Authorized Customer-Merchant Transactions,” which is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to systems and methods for customer-merchant transactions. More specifically, the present invention relates to systems and methods for user authorized transactions between customers and merchants.

Many of today's commercial transactions are conducted based on credit, such as a credit card, debit card, and/or other account. However, merchants are often victimized by credit card fraud and other fraudulent transactions, leaving the merchant without payment and with lost goods and/or services provided to a non-paying customer. There is an unmet need for transaction systems and methods that provide payment to a merchant before goods and/or services are rendered.

Therefore, there is an unmet need for improved user authorized transaction systems and methods. Systems and methods providing relative security for a merchant would be highly desirable and have not been identified or implemented by any of today's systems.

### BRIEF SUMMARY OF THE INVENTION

Certain embodiments of the present invention provide methods and systems for user authorized customer-merchant transactions.

Certain embodiments provide a method for facilitating user authorized transactions between a customer and a merchant. The method includes generating account information for a merchant for a transaction, the account information relating to payment of funds to a merchant in exchange for a good or service pending user authorization. The method also includes facilitating access to a user account to view transaction information for the transaction, the transaction information corresponding to the account information provided to the merchant. The method further includes authorizing payment from account for the transaction based on user approval following user review of the transaction information.

Certain embodiments provide a method for configuring an account for user authorized transactions. The method includes establishing a user-configurable account for good and/or service transactions between a user and at least one merchant. The method includes establishing a personal identification number for the account. The method also includes providing an account number and value associated with the account for use with the at least one merchant. The method further includes generating a transaction identification number for a user-merchant transaction based on the account number and the personal identification number. Additionally, the method includes facilitating approval of the user-merchant transaction based on the transaction identification number, the account number, and the personal identification number.

Certain embodiments provide a customer-merchant transaction system. The system includes account information identifying a prepaid account associated with an account holder. The system also includes a database storing transaction information related to the account information. The system further includes an authorization engine configured to allow the account holder to authorize a transaction associated with the account information based on a review of the transaction information.

### BRIEF DESCRIPTION OF SEVERAL VIEWS OF THE DRAWINGS

FIG. 1 illustrates a customer-merchant transaction system used in accordance with an embodiment of the present invention.

FIG. 2 illustrates a flow diagram for a method for card initialization in accordance with an embodiment of the present invention.

FIG. 3 illustrates a flow diagram for a method for card-based transactions in accordance with an embodiment of the present invention.

FIG. 4 illustrates a card-based transaction system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

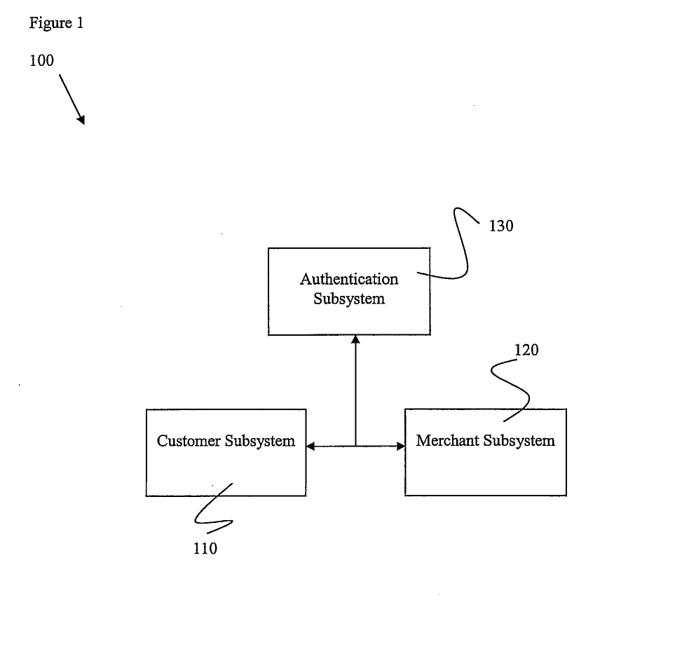

FIG. 1 illustrates a customer-merchant transaction system 100 used in accordance with an embodiment of the present invention. The system 100 includes a customer subsystem 110, a merchant subsystem 120 and an authorization subsystem 130.

The components of the system 100 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain components may be integrated in various forms and/or may be provided as software and/or other functionality on a computing device, such as a computer.

The authorization subsystem 130 is used with the customer subsystem 110 and merchant subsystem 120 to facilitate customer-merchant transactions for goods and/or services. The customer subsystem 110 and merchant subsystem 120 may include an electronic subsystem, a computer-based subsystem, a telephone-based subsystem, a card-based subsystem, a biometric subsystem, etc. The customer subsystem 110 and merchant subsystem 120 may include human participants, for example. The authorization subsystem 130 may include a web-based subsystem, a telephone-based subsystem, a computer-based subsystem, other electronic subsystem, etc. The authorization subsystem 130 may also include human participants, for example.

In operation, the customer subsystem 110 initiates a transaction with the merchant subsystem 120. The transaction may involve a purchase of goods and/or services, for example. The customer subsystem 110 initiates the transaction by providing prepaid credit or voucher information, for example, to the merchant subsystem 120. The customer subsystem 110 and merchant subsystem 120 log the transaction for verification. The customer subsystem 110 then interacts with the authorization subsystem 130 to authorize the transaction. After the customer subsystem 110 has authorized the transaction, the merchant subsystem 120 receives confirmation from the authorization subsystem 130. The merchant subsystem 120 then completes the transaction.

For example, a customer initiates a purchase of an item via an Internet website for a merchant. The customer subsystem 110 (e.g., a web browser) interacts with the merchant subsystem 120 (e.g., a web site/server) to purchase a good. The customer subsystem 110 provides the merchant subsystem 120 with credit account information (e.g., an online credit account, a prepaid card account, an anonymous prepaid account, etc.) to conduct the transaction. The merchant subsystem 120 logs the customer information with the transaction. The authorization subsystem 130 receives information regarding the transaction and the customer account information.

The customer subsystem 110 then accesses the authorization subsystem 130 to approve the transaction. For example, the customer accesses an account approval website via a web browser. The customer may then view pending transactions associated with his/her account. The customer subsystem 110 facilitates approval or disapproval of the pending transaction(s). The authorization subsystem 130 transmits approval or disapproval information to the merchant subsystem 120.

If a transaction is approved, then the merchant subsystem 120 processes payment and executes the transaction. Payment may be facilitated by personal identification number (PIN), Internet, credit card, debit card, prepaid card, radio frequency identifier (RFID), electronic funds transfer (EFT), and/or other electronic payment, for example. If a transaction is denied, then the merchant subsystem 120 cancels the transaction. For example, the customer approves a transaction on an account website. The payment then is released to the merchant. The merchant then fills the order for the good to the customer.

The customer subsystem 110 and/or authorization subsystem 130 may be associated with a user account, for example. The account may be configured for user authorized transactions. The user account may be a prepaid account, for example, and/or may be tied to another account, such as a credit card or bank account, for refreshing a balance. The account may be opened in conjunction with a card and/or with a virtual on-line representation of a card or account, for example. Information, such as an account number and a balance or value, may be associated with the account. A personal identification number and/or other identifier may be associated with the account. Additionally, a transaction identification number may be generated for a transaction based on the account number and the personal identification number. The transaction number may be used to identify and approve/deny a pending transaction, for example.

In certain embodiments, a user account may be used in an open loop and/or closed loop environment. For example, in an “open loop” environment, an account may be used for transactions with any participating merchant (e.g., any merchant that accepts the account network). In a “closed loop” environment, an account may be used for transactions only with specific merchant(s), for example.

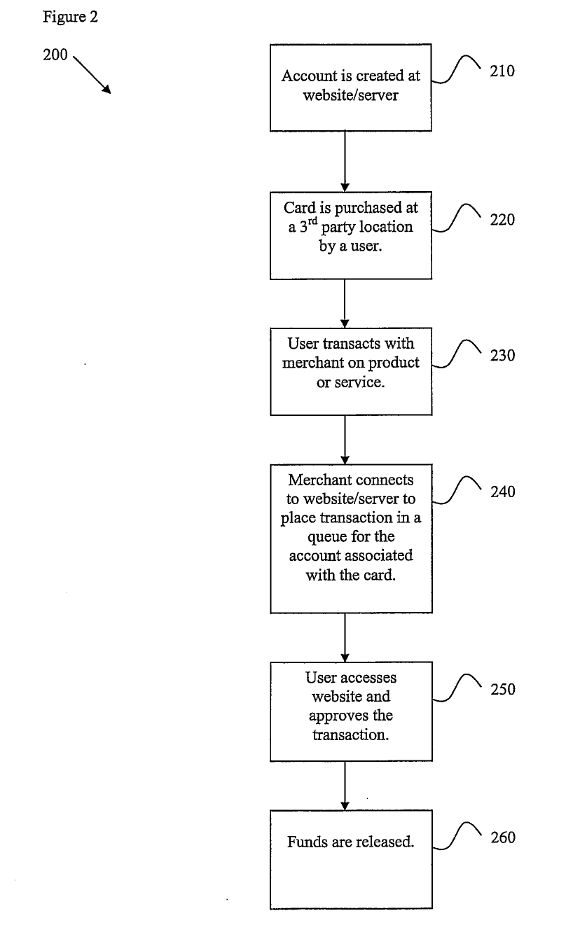

FIG. 2 illustrates a flow diagram for a method 200 for customer-merchant transactions in accordance with an embodiment of the present invention. At step 210, an account is created. For example, an account may be created via a website. The account may take one or more of a variety of forms. For example, the account can be tied to a card number and be associated with a pre-assigned username and password that come with the card. As another example, the account can be used for any type of user-approved transaction, such as a credit transaction, a debit transaction, a PIN, an Internet transaction, a RFID transaction, and/or other electronic transaction. A user may add one or more cards or other identifiers to the account and/or an administrator may add one or more cards or other identifiers to the account. In certain embodiments, an account may be created for use with one or more specific merchant(s) and/or for general use with any participating merchant.

At step 220, a card is purchased at a third party location by a user. For example, the user buys a card at a grocery store, department store, convenience store, kiosk, website, etc. In certain embodiments, a virtual card or other representation may be activated on-line without visiting a physical location, for example. At step 230, the user transacts with a merchant for a product and/or service. For example, the user presents the card to a store cashier to purchase a product and/or service.

At step 240, the merchant connects to an account website/server to place the transaction. The transaction is stored with respect to the user account associated with the card. At step 250, the user then accesses the account website/server to approve the transaction. For example, the user logs on to the account website, views the pending transaction(s) awaiting approval, and indicates approval or authorization to honor the payment request and process the transaction.

At step 260, funds are released to the merchant to pay for the transaction. The merchant then provides the product and/or service to the user. In certain embodiments, a courier, such as Federal Express, UPS, DHS and/or the United States Postal Service, may settle a transaction on behalf of a merchant by collecting funds upon delivery of goods, for example.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Certain embodiments provide a prepaid card facilitating a secure transaction between a card holder and a merchant. The prepaid card allows a merchant to record the card information without requiring detailed information regarding the card holder. The card holder then accesses an account to review and authorize the transaction. Upon authorization, the transaction is executed. In certain embodiments, the transaction may be an anonymous transaction.

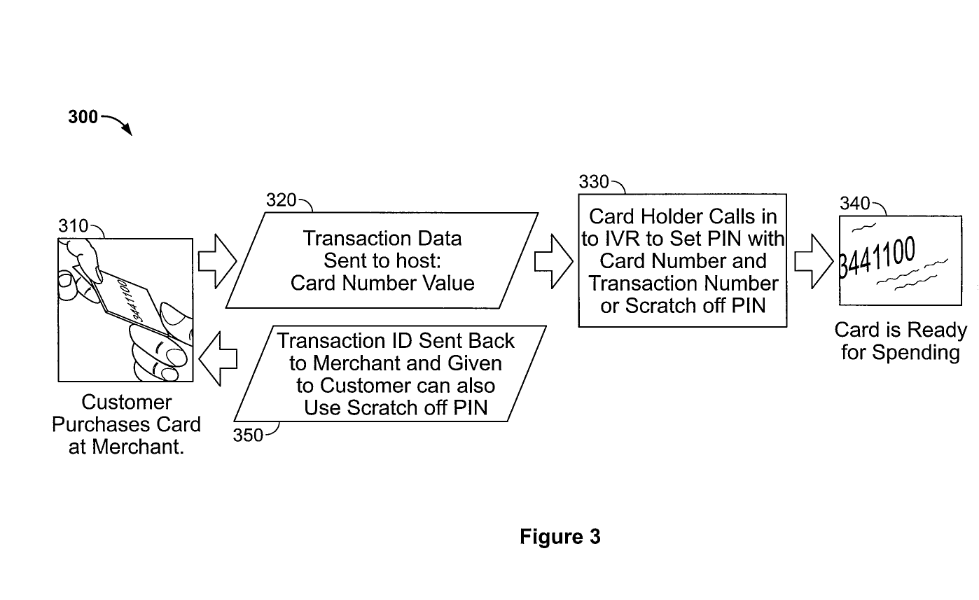

FIG. 3 illustrates a flow diagram for a method 300 for card initialization in accordance with an embodiment of the present invention. At step 310, a customer purchases a card at a merchant. For example, a customer buys a prepaid card at a grocery store or other business. Alternatively, a customer may purchase a virtual or electronic implementation of the card online.

At step 320, transaction data is sent to a host. Transaction data includes card number and value, for example. For example, a purchased card may have a value of $100 and be identified by a card number 0000001. The value and card number are sent to a host, such as a transaction processor and/or database, to record and track the card's identification and value.

At step 330, the card holder calls an interactive voice response (“IVR”) system or electronically accesses a transaction processor, such as a server or other computing system, to set a PIN associated with the card number. Using an IVR system, a user interacts with a database using a touch-tone telephone to acquire information from and/or enter data into the database. Using IVR or an internet-accessible server, the user's interaction with the database may be facilitated without other human interaction. However, in an embodiment, a card holder may interact with a human agent to activate the card and such a PIN. Alternatively, the card may include a “scratch off” PIN to be used with the card.

At step 340, the card is ready to be used to purchase goods and/or services at a participating merchant. That is, the card number, value and PIN have been recorded and associated with the card holder. The card holder may thus use the card to facilitate transactions without providing additional personal information to a merchant. The card holder approves transactions through the card provider rather than through the merchant so that the merchant does not receive a certain level of detail identifying the buyer. In certain embodiments, the level of detail or anonymity can be configurable based on one or more factors such as type of transaction, amount of transaction, type of merchant, type of card holder (e.g., 18 years of age or older, satisfactory credit rating, etc.).

At step 350, a transaction identifier (“ID”) is transmitted to the merchant and provided to the customer. In an embodiment, a personal identification number (“PIN”) such as a “scratch off” PIN on or accompanying the card, may be used by a customer to facilitate a transaction using the card.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

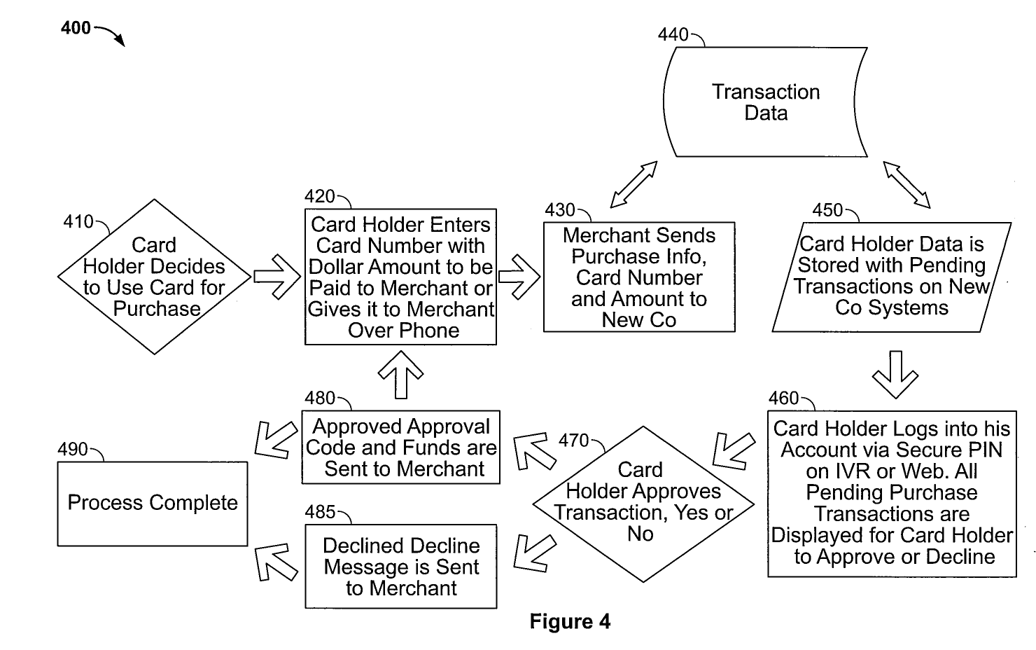

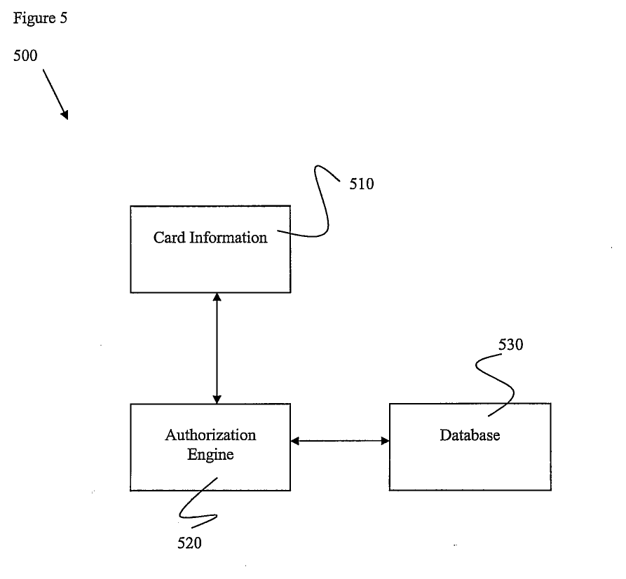

FIG. 4 illustrates a flow diagram for a method 400 for card-based transactions in accordance with an embodiment of the present invention. At step 410, a card is used for a purchase. For example, a user physically or virtually presents a card for in-person, online and/or telephone purchase of a good or service.

At step 420, the card holder provides a card number and a monetary amount to be paid to a merchant. The card number and amount may be entered electronically by the card holder and/or provided to the merchant by the card holder in person or over the telephone.

At step 430, the merchant sends purchase information, card number and amount to a transaction processor. Transaction data 440 includes information such as purchase information, card number and amount passed between the merchant and the transaction processor.

At step 450, card holder data is stored with pending transactions. For example, the transaction associated with the card is stored in a database for card holder review. The database reflects the card number, amount and other purchase information, for example.

At step 460, the card holder accesses his or her account. For example, a card holder may access his or her account via a secure PIN using IVR, World Wide Web and/or other access medium. Pending purchase transactions are displayed for the card holder to approve or decline.

At step 470, the card holder approves or denies the transaction. For example, the card holder may press a telephone button, keyboard button, select a button or icon on a display screen, verbalize, etc. to approve or disapprove one or more pending transactions associated with the card. At step 480, if the card holder approves the transaction, an approval code and funds are transmitted to the merchant. At step 485, if the card holder declines the transaction, a decline message is sent to the merchant. At step 490, the transaction process is completed.

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

FIG. 5 illustrates a card-based transaction system 500 in accordance with an embodiment of the present invention. The system 500 includes card information 510, an authorization engine 520, and a database 530.

The components of the system 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain components may be integrated in various forms and/or may be provided as software and/or other functionality on a computing device, such as a computer.

The card 510 is a prepaid card that may be associated with a card holder using a PIN and/or other identifier. In certain embodiments, the card 510 is a re-usable card. In certain other embodiments, the card 510 is a one-time, non-reloadable card. Through use of the card, no personal information is gathered regarding the card holder (the purchaser of the goods and/or services) by a merchant. In certain embodiments, a minimal amount of information is gathered depending upon a type of transaction. The card 410 may include a magnetic strip, a bar code, a microchip, a radio frequency identifier, a memory and/or other processing and/or identification device, for example.

The authorization engine 520 allows a card holder to approve or deny transactions using the card information 510. Transactions are stored in the database 530. The database 530 may be a database and/or other data storage or memory storing and organizing data, for example. The authorization engine 520 may be an IVR system and/or server, such as a web-based server, allowing a user to access the engine 520, view relevant transaction data from the database 530 and provide input to authorize or deny one or more pending transactions.

In certain embodiments, the authorization engine 520 may be accessed by and/or implemented in conjunction with any device through which a user may access a website, such as a personal computer, a personal digital assistant, an Internet-through-television device, a phone or any type of many available wireless devices available in the market.

In certain embodiments, the database 530 may be integrated with the authorization engine 520 to store transaction and card data, process data and facilitate transactions. As such, the authorization engine 520 may include a database server, a web server, a firewall, etc. to connect to the Internet, telephone network and/or other private network, for example.

If a firewall is used, the firewall can perform a number of filtering functions and network address translation in order to safeguard the authorization engine 520/database 530 from unauthorized access. The firewall may also encrypt messages using known public key/private key encryption methods.

The system may also include a load balancing router that forwards messages received from the firewall and forwards the messages to one or more web servers/data servers making up the authorization engine/database. The load balancing router may also forward messages received from the authorization engine 520 to the firewall. In this manner, the load balancing router distributes tasks to be performed to one of a plurality of servers in order to distribute processing demands. For example, the web servers access the database servers to retrieve and store information in response to received messages and transmit reply messages. The database servers store database(s)/table(s) which include card and transaction information, for example.

Thus, certain embodiments provide systems and methods for improved customer-merchant transactions. Certain embodiments provide systems and methods using purchaser authorization to complete a purchase. Certain embodiments provide systems and methods for merchants having a high cost cash on delivery (“COD”) business model or high interchange credit card activity. Certain embodiments reduce interchange fees paid to networks for card-not-present transactions. Transactions may be facilitated in a variety of environments, such as credit, debit, open loop and closed loop.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of a variety of electronic transactional systems. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for facilitating user authorized customer-merchant transactions, said method comprising:
generating account information for a merchant for a transaction, said account information relating to payment of funds to a merchant in exchange for a good or service pending user authorization;
facilitating access to a user account to view transaction information for said transaction, said transaction information corresponding to said account information provided to said merchant; and
authorizing payment from account for said transaction based on user approval following user review of said transaction information.

2. The method of claim 1, further comprising logging said transaction for verification by said user.

3. The method of claim 1, further comprising completing said transaction based on receipt of said authorization and payment.

4. The method of claim 1, wherein said accessing step further comprises accessing said account via an account approval website to view pending transactions associated with said account.

5. The method of claim 1, wherein said providing step further comprises providing a card number and value to a merchant for a transaction.

6. The method of claim 1, wherein said authorizing step further comprises authorizing said transaction using an interactive voice response system.

7. The method of claim 1, wherein said providing step further comprises providing account information to a merchant to facilitate a transaction without providing personal information to a merchant.

8. A method for configuring an account for user authorized transactions, said method comprising:
establishing a user-configurable account for good and/or service transactions between a user and at least one merchant;
establishing a personal identification number for said account;
providing an account number and value associated with said account for use with said at least one merchant;
generating a transaction identification number for a user-merchant transaction based on said account number and said personal identification number; and
facilitating approval of said user-merchant transaction based on said transaction identification number, said account number, and said personal identification number.

9. The method of claim 8 wherein said user-configurable account is funded through a connection with a user financial account at a financial institution.

10. The method of claim 8 wherein said user-configurable account is configured for use with a particular merchant or set of merchants.

11. The method of claim 8, wherein said user-configurable account is configured for use with any participating merchant.

12. The method of claim 8, wherein said personal identification number comprises a scratch off personal identification number found on a card corresponding to the account.

13. A customer-merchant transaction system, said system comprising:
account information identifying a prepaid account associated with an account holder;
a database storing transaction information related to said account information; and
an authorization engine configured to allow said account holder to authorize a transaction associated with said account information based on a review of said transaction information.

14. The system of claim 13, further comprising a merchant subsystem completing said transaction based on said authorization of said transaction.

15. The system of claim 13, wherein said authorization engine is adapted to allow said user to authorize said transaction by accessing an account via an account approval website to view and approve pending transactions associated with said account.

16. The system of claim 13, wherein said prepaid account comprises an account associated with a user financial account with a financial institution, said prepaid account refreshed by said user financial account.

17. The system of claim 13, wherein said prepaid account is configured for use with a particular merchant or set of merchants.

18. The system of claim 13, wherein said prepaid account is configured for use with any participating merchant.

19. The system of claim 13, wherein said account information further comprises a card number and value for the transaction without personal information for said account holder.

20. The system of claim 13, wherein said authorization engine comprises an interactive voice response system to allow said account holder to authorize said transaction.
